(19) United States
(12) Patent Application Publication
(10) Pub. No.: US 2005/0109564 A1
(43) Pub. Date: May 26, 2005

(54) Band brake system apparatus and control method

(76) Inventors: Shushan Bai, Ann Arbor, MI (US); Joel M. Maguire, Northville, MI (US)

Correspondence Address: LESLIE C. HODGES;General Motors Corporation, Mail Code 482-C23-B21, P.O. Box 300, Detroit, MI, 48265-3000, US

(21) Appl. No.: 10/722,080

(22) Filed: Nov. 25, 2003

(51) Int. Cl. F16D 55/00

(52) U.S. Cl. 188/71.1

(57) ABSTRACT

A band brake system apparatus and control provide for controlled engagement of a band about a drum in a power transmission apparatus. The control apparatus includes force sensors and speed sensors, which supply signals to an electronic control mechanism, which in turn establishes a desired force to be applied to the band.

### TECHNICAL FIELD

This invention relates to brake mechanisms for power transmissions and, more particularly, to band brake type devices for automatic power transmissions.

### BACKGROUND OF THE INVENTION

Automatic shifting power transmissions, such as those used in passenger vehicles and trucks incorporate a plurality of planetary gearsets that are interconnected with either positive interconnections or friction interconnections. The friction interconnections include torque-transmitting mechanisms, such as rotating clutches or stationary brakes. The brake mechanisms used in automatic transmissions are generally either disc type brake mechanisms or band type brake mechanisms.

The band type brake mechanisms have an advantage in that they provide a more compact structure. The band brakes also have a self-energizing action and a high torque gain. The torque capacity of a band is relatively difficult to control in order to achieve a smooth ratio interchange in using only a linear actuator control.

### SUMMARY OF THE INVENTION

It is an object of this invention to provide an improved brake apparatus and control system for automatic transmissions.

In one aspect of the present invention, the brake apparatus includes an actuator mechanism and an anchor mechanism.

In another aspect of the present invention, the anchor mechanism includes a force sensor that provides a signal proportional to the force at the anchor of the band.

In yet another aspect of the present invention, a speed sensor is employed to record the speed of the transmission member to be braked.

In still another aspect of the present invention, an electronic control unit receives the signals of both the anchor force sensor and the drum speed sensor to provide a control signal to the linear actuator.

In yet still another aspect of the present invention, the desired brake torque and measured drum speed provide a desired anchor force, which is added to the measured anchor force and an error correction and provided to a feedback control mechanism in the electronic control unit to establish a control signal for the actuator to increase or decrease the force at the actuator as required.

### DESCRIPTION OF THE DRAWINGS

FIG. 1 is a diagrammatic representation of a brake band system and control mechanism.

FIG. 2 is a block diagram of a portion of the control mechanism for the brake band system.

FIG. 3 is a diagrammatic representation of another embodiment of the brake band system and control mechanism.

FIG. 4 is yet another diagrammatic representation of an embodiment of the present invention.

FIG. 5 is a further embodiment and diagrammatic view representing the present invention.

### DESCRIPTION OF THE EXEMPLARY EMBODIMENTS

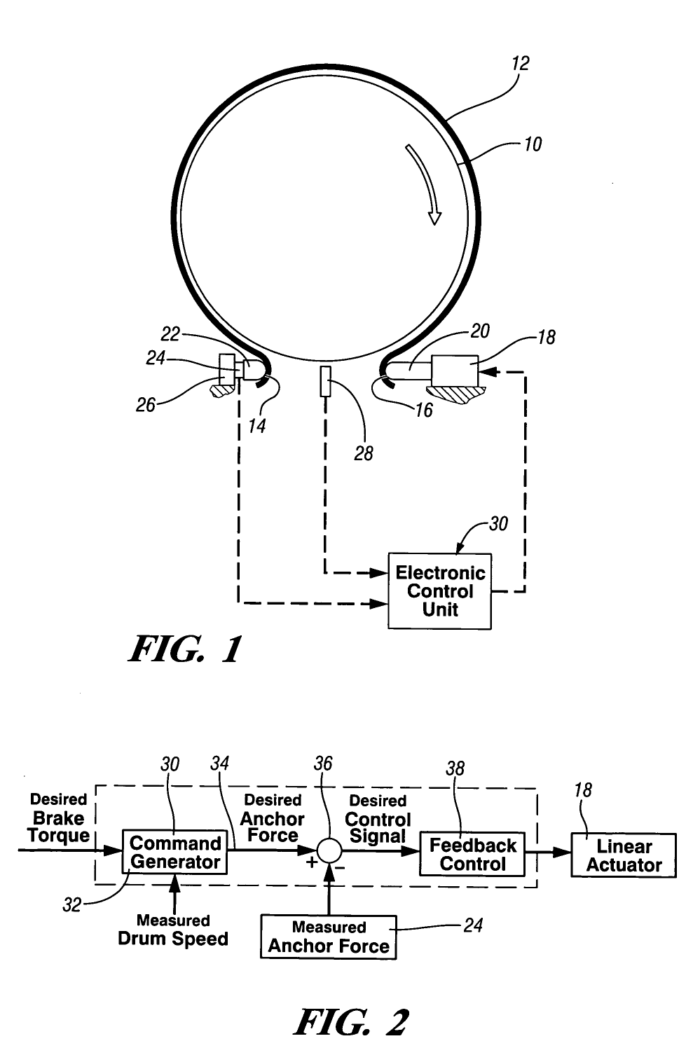

FIG. 1 describes a rotatable transmission drum 10 surrounded by a brake band 12. The brake band 12 has an end anchor portion 14 and an apply portion or actuator end 16. The apply portion 16 is actuated by a linear actuator mechanism 18, which includes an actuator pin 20 engaging the actuator end 16.

The anchor end 14 is engaged by an anchor pin 22, which includes an anchor force sensor 24 and a stationary anchor portion 26. The anchor force sensor 24 records or establishes a signal proportional to the amount of force at the anchor pin 22, which is the same as the force at the anchor end 14.

The rotary speed of the drum 10 is sensed by a drum speed sensor 28. The anchor force sensor 24 submits a force signal to an electronic control unit (ECU) 30. The electronic control unit 30 is a conventional electronic control, which can incorporate a preprogrammed digital computer capable of establishing signals for control of various elements within a power transmission, not shown. The drum speed sensor 28 also supplies a signal to the electronic control unit 30 and in turn the electronic control unit 30 supplies a signal to the linear actuator 18 to establish the force required on the actuator end 16, such that the proper braking force is available to the drum 10.

As seen in FIG. 2, the ECU 30 receives a desired brake torque signal and a drum speed signal, which are given to a command generator 32. The command generator 32 establishes a desired anchor force 34, which is delivered to an error correction mechanism 36. The error correction mechanism 36 also receives a measured anchor force from the anchor force sensor 24. These forces are combined and directed to a feedback control circuit or mechanism 38, which establishes and issues a control actuator signal, which is distributed to the linear actuator 18. The linear actuator force is, of course, is either increased, decreased, or remains the same depending upon the signals received at the ECU 30.

The ECU 30 also receives a plurality of other signals that are not shown, such as engine speed, vehicle speed, a present transmission ratio, the on-coming transmission ratio, engine throttle setting, and various other signals. These signals establish how the transmission is to respond to various changes that are commanded as a result of the signals generated.

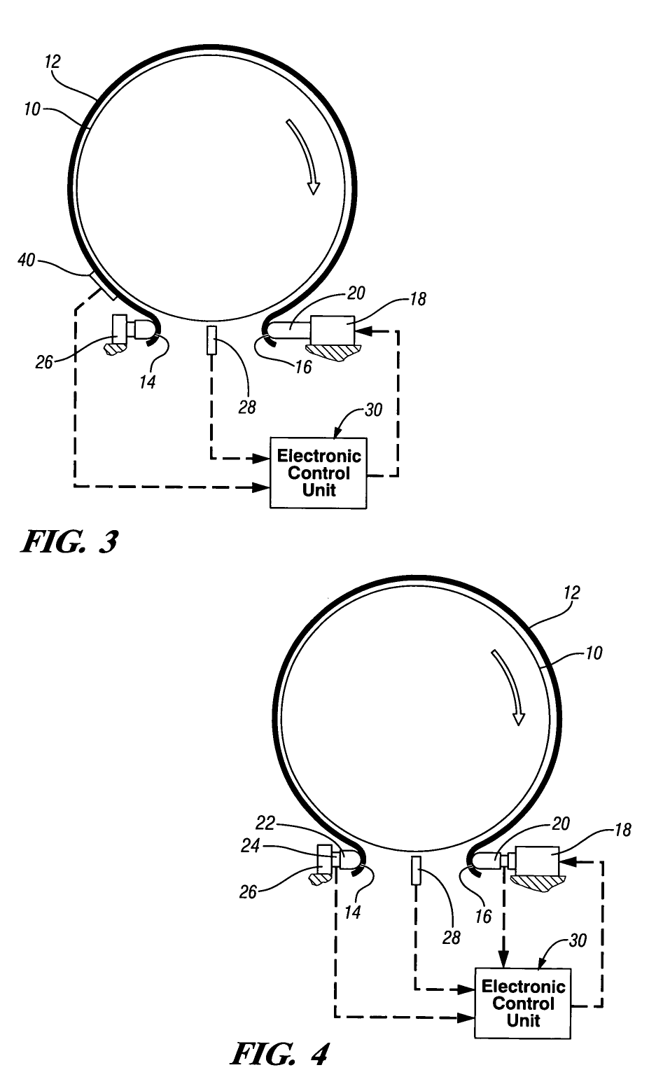

The diagrammatic representation of FIG. 3 is similar to that of FIG. 1 and the corresponding parts have been given the same numerical designations. The anchor 26 is established or installed without an anchor force sensor mechanism. In place of the anchor force sensor mechanism a strain gauge 40 is secured to the band 12 near the anchor end 14. The strain gauge 40 supplies a signal to the electronic control unit 30 that is proportional to the force at the anchor end 14 of the band 12. The control 30 operates in substantially the same manner; that is, the ECU 30 receives a brake torque signal and a measured drum speed signal, which are combined to provide a desired anchor force signal, which in turn is combined with the signal received from the strain gauge 40 to establish the desired actuator force of the actuator 18.

FIG. 4 describes a brake band that is similar to the brake band apparatus described in FIG. 1 with the inclusion or addition of an actuator force sensor 42 disposed between the linear actuator 18 and the actuator pin 20. With this system, both the force at the anchor end 14 and the force at the apply end 16 are both known. The signals represented by those forces are distributed to the electronic control unit 30, which establishes the desired linear actuator force to be applied at the actuator end 16. The actuator force sensor 42 issues a signal, which provides the ECU 30 with the information as to the actual linear actuator force.

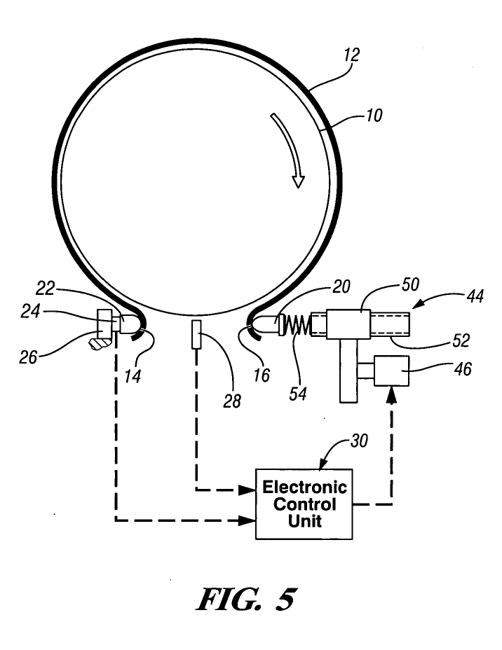

The band brake apparatus and control shown in FIG. 5 is similar to that described above for FIGS. 1 through 4 with the exception that the actuator mechanism 18 is replaced with a torque-to-thrust assembly 44. The torque-to-thrust assembly 44 includes an electric motor 46, a pair of transfer gears 48 and 50, a linear drive mechanism or actuator 52, and a spring element 54.

As is well known with torque-to-thrust mechanisms, the electric motor 46 will provide rotary motion of the gears 48 and 50 resulting in linear motion of the actuator 52. The thrust force generated at the actuator 52 is applied through the spring 54 to the actuator pin 20 and therefore the actuator end 16. The signals generated by the anchor force sensor 24 and the drum speed sensor 28 are issued to the electronic control unit 30, which generates the proper signal for the electric motor 46, which in turn establishes the linear actuator force to be applied to the actuator end 16.

1. A brake system comprising:
a rotatable drum;
a band brake surrounding a portion of said drum including an anchor end and an apply end;
an anchor member engaging said anchor end including sensor means to provide a reaction signal proportional to the force generated at said anchor end;
an apply means for generating an apply force at said apply end to enforce engagement of said brake band and said drum; and
control means responsive to said reaction signal to adjust said apply force to a desired apply force.

2. The brake system defined in claim 1 further comprising:
speed sensing means for generating a speed signal proportional to a speed of said drum; and
said control means responsive to both said reaction signal and said speed signal to adjust said apply force to a desired apply force.

3. The brake system defined in claim 1 further comprising:
a force sensing means responsive to said apply force for generating an apply signal proportional to said apply force; and
said control means responsive to all of said reaction signal and said speed signal and said apply signal to adjust said apply force to a desired apply force.

4. The brake system defined in claim 1 further wherein:
said apply means is a member of a group consisting of a linear actuator means and a torque to thrust means.

5. A method of establishing an actuator force in a brake system having a rotating drum and a brake band, said method comprising the steps of:
establishing a desired brake torque;
determining a speed of said drum;
determining a desired anchor force;
measuring an actual anchor force at said brake band;
comparing said desired anchor force and said actual anchor force; and
issuing an actuator control signal to a brake actuator signal to an actuator at said brake band to apply an actuator braking force thereto proportional to said brake actuator signal.

6. The method of establishing an actuator force in a brake system defined in claim 5 further comprising the steps of:
determining an actual actuator force at said actuator; and
comparing said actual actuator force with said proportional brake actuator force.
